(19) United States
(12) Patent Application Publication
(10) Pub. No.: US 2014/0185228 A1
(43) Pub. Date: Jul. 3, 2014

(54) READ/WRITE FUNCTION PROVIDING DEVICE

(71) Applicant: Mobile Business Promote Co., Ltd., Fukuoka-shi (JP)

(72) Inventors: Koichi IIZUKA, Fukuoka (JP); Masatoshi FUJITA, Tokyo (JP)

(73) Assignee: Mobile Business Promote Co., Ltd., Fukuoka-shi (JP)

(21) Appl. No.: 14/038,956

(22) Filed: Sep. 27, 2013

(30) Foreign Application Priority Data
Dec. 27, 2012 (JP) 2012-284045

(51) Int. Cl. G06F 1/16

(52) U.S. Cl. CPC G06F 1/16
USPC 361/679.32

(57) ABSTRACT

Provided is a read/write function providing device that allows a position over which an IC card is to be held to be easily found. The read/write function providing device is configured to be attachable to and detachable from a display device provided with a display screen. The read/write function providing device includes first and second antennas for forming a path for communication with an external communication device, an external connector connectable to the display device, and a connection circuit that connects the first and second antennas to the external connector. When the read/write function providing device is attached to the display device, the wireless communication path provided by the detectable area of the first antenna and the detectable area of the second antenna is positioned above the display screen.

### BACKGROUND OF THE INVENTION

1. Field of the Invention

The present invention relates to a read/write function providing device.

2. Description of the Related Art

There is known a read/write device that reads a predetermined electric signal through transmission and reception of radio waves. For example, a read/write function providing device described in Patent Document 1 includes: a transceiver capable of wireless communication with an IC card; and a controller module connectable to the transceiver through a connector.

Patent Document 1: PCT International Application No. PCT/US00/05067, published as WO00/67100.

However, in such a read/write function providing device described in Patent Document 1, an antenna for communication with an IC card is often built into a casing. One technique to solve such a problem is to provide, on the surface of the casing, an identifying mark indicating a position over which the IC card is to be held. However, the user is not always aware of such an identifying mark, so that the IC card is held over every portion of the casing again and again.

Recently, portable terminals such as smart phones are equipped with a read function, but there are no portable terminals having both the read function and a write function. In a portable terminal equipped with the read function, a large display screen is disposed in front of the casing, so that the position over which an IC card is to be held is often provided on the rear side of the casing. Therefore, in such a portable terminal equipped with the read function, it is difficult to identify the position over which an IC card is to be held.

### SUMMARY OF THE INVENTION

The present invention has been made in view of the foregoing circumstances, and it is an object to provide a read/write function providing device that allows the position over which an external communication device such as an IC card is to be held to be easily found.

The present invention provides a read/write function providing device configured to be attachable to and detachable from a display device provided with a display screen, the read/write function providing device including: an antenna unit for forming a wireless communication path for wireless communication with an external communication device; an interface unit that is connectable to the display device; and a connection circuit that connects the antenna unit to the interface unit. In the read/write function providing device with the above configuration, when the read/write function providing device is attached to the display device, the wireless communication path provided by a detectable area of a first section of the antenna unit and a detectable area of a second section of the antenna unit is located above the display screen.

Preferably, when the read/write function providing device is attached to the display device, the antenna unit is located at a circumference of the display screen. Preferably, when the read/write function providing device is attached to the display device, an overlapping area of the detectable area of the first section and the detectable area of the second section is located above the display screen.

Preferably, the read/write function providing device further comprises a casing having the antenna unit and the interface unit and including an accommodating section formed therein, for accommodating the display device when the read/write function providing device is attached to the display device. The casing includes: an antenna casing including the antenna unit; and an interface unit casing including the interface unit and configured to be attachable to and detachable from the antenna casing, and the accommodating section is formed by attaching the interface unit casing to the antenna casing. Preferably, the read/write function providing device further comprises a moving mechanism that allows the interface unit casing to move relative to the antenna casing between an accommodating section-forming position at which the accommodating section is formed and an escape position escaped from the accommodating section-forming position. Preferably, the read/write function providing device further comprises an attaching-detaching mechanism that allows the interface unit casing to be attached to and detached from the antenna casing, and the attaching-detaching mechanism includes a magnet.

Preferably, the read/write function providing device further comprises a casing having the antenna unit and the interface unit and including an accommodating section formed therein, for accommodating the display device when the read/write function providing device is attached to the display device. The casing includes: an antenna casing including the antenna unit; and an interface unit casing including the interface unit and configured to be attachable to and detachable from the antenna casing, and the accommodating section is formed in the antenna casing.

Preferably, the casing includes: an external power source-side power receiving unit that receives power from an external power source; and a display device-side power supply unit that supplies the power received by the external power source-side power receiving unit to the display device.

Preferably, the interface unit casing includes: the external power source-side power receiving unit; and the display device-side power supply unit. Preferably, the casing is formed into a rectangular parallelepiped shape, and, when the read/write function providing device is attached to the display device, the interface unit casing forms part of a side surface of the casing, with a surface of the casing on a side close to the display screen being defined as a top surface.

Preferably, the read/write function providing device further comprises a radio wave shielding member that is positioned between a display device antenna provided in the display device and one of the first and second sections when the read/write function providing device is attached to the display device.

Preferably, the read/write function providing device further comprises a signal output unit that outputs the first control signal for the display device, and the first control signal is used to instruct the display device to show, on the display screen, a display indicating that communication between the external communication device and one of the first and second sections is enabled. Preferably, the read/write function providing device further comprises an operation button provided in the casing, and the signal output unit outputs, as the first control signal, an operation signal from the operation button to the display device. Preferably, the read/write function providing device further comprises a switching unit that switches between a communication enabled mode in which the communication between the external communication device and one of the first and second sections is enabled and a communication disabled mode in which the communication is disabled, and, when the signal output unit outputs the first control signal to the display device, the switching unit switches to the communication enabled mode.

Preferably, the read/write function providing device further comprises a signal input unit to which the second control signal outputted from the display device is inputted, and the second control signal outputted from the display device is used to switch to the communication enabled mode in which communication between the external communication device and one of the first and second sections is enabled. Preferably, the read/write function providing device further comprises a switching unit that switches between the communication enabled mode in which the communication between the external communication device and one of the first and second sections is enabled and a communication disabled mode in which the communication is disabled, and, when the second control signal outputted from the display device is inputted to the signal input unit, the switching unit switches to the communication enabled mode in which the communication between the external communication device and one of the first and second sections is enabled.

Preferably, the read/write function providing device further comprises a communication unit that communicates with the external communication device through one of the first and second sections, and, when a communication protocol executed by a display device-side communication unit provided in the display device is defined as a display device-side communication protocol, a communication protocol executed by the communication unit is different from the display device-side communication protocol.

The present invention can provide an excellent effect in that a place over which an external communication device such as an IC card is to be held can be easily found.

### BRIEF DESCRIPTION OF THE DRAWINGS

FIG. 1 is a perspective view illustrating the outline of a read/write function providing device attached to a display device;

FIG. 2 is a perspective view illustrating the outline of the display device and the read/write function providing device;

FIGS. 3A and 3B are cross-sectional views taken along line III-III in FIG. 5A, illustrating the outline of the read/write function providing device;

FIG. 4A is an exploded perspective view illustrating the outline of the read/write function providing device; FIG. 4B is a cross-sectional view taken along line IVb-IVb in FIG. 5A, illustrating the outline of the casing of the read/write function providing device; FIG. 4C is a cross-sectional view taken along line IVc-IVc in FIG. 5A, illustrating the outline of the casing of the read/write function providing device;

FIG. 5A is a front view illustrating the outline of the read/write function providing device attached to the display device; FIG. 5B is cross-sectional view taken along line Vb-Vb in FIG. 5A, illustrating the outline of the casing of the read/write function providing device;

FIG. 6 is a block diagram illustrating the outline of the display device and the read/write function providing device;

FIG. 7 is a block diagram illustrating the outline of an antenna controller;

FIG. 8 is a front view illustrating the outline of the display device with the read/write function providing device being attached thereto and with an image urging the user to place an IC card being displayed;

FIG. 9 is an exploded perspective view illustrating the outline of a moving mechanism provided in the read/write function providing device;

FIGS. 10A and 10B are front views illustrating the outline of a read/write function providing device;

FIGS. 11A and 11B are front views illustrating the outline of a read/write function providing device; and

FIG. 12 is a front view illustrating the outline of a read/write function providing device.

### DETAILED DESCRIPTION OF THE PREFERRED EMBODIMENTS

Embodiments of the present invention will next be described with reference to the accompanying drawings.

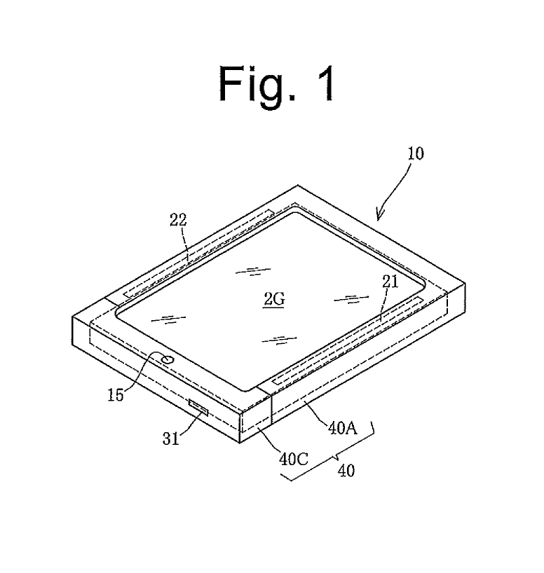

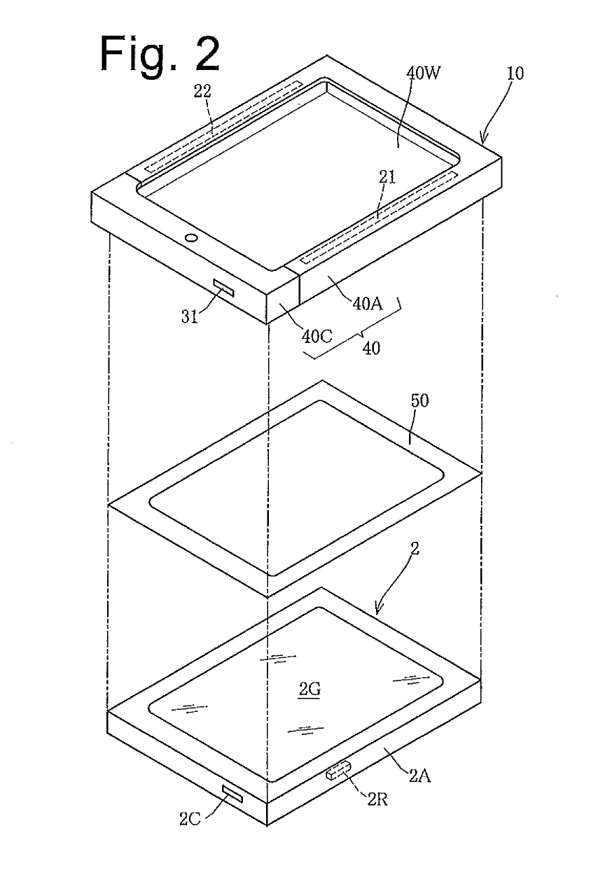

As shown in FIGS. 1 and 2, a read/write function providing device 10 is attached to a display device 2. As shown in FIG. 2, the display device 2 is a portable terminal such as a mobile phone, a smart phone, a tablet, or a tablet PC and includes a casing 2A, a display screen 2G provided in the casing 2A, and an input-output connector 2C provided in the casing 2A.

The casing 2A is formed into a rectangular parallelepiped shape. The display screen 2G is disposed on the top surface of the casing 2A, and the input-output connector 2C is disposed on a side surface. The display screen 2G functions as output means to which a predetermined image is outputted under control of a processing unit (described later in detail) accommodated in the casing 2A. The display screen 2G functions also as input means through a touch panel accommodated in the casing 2A.

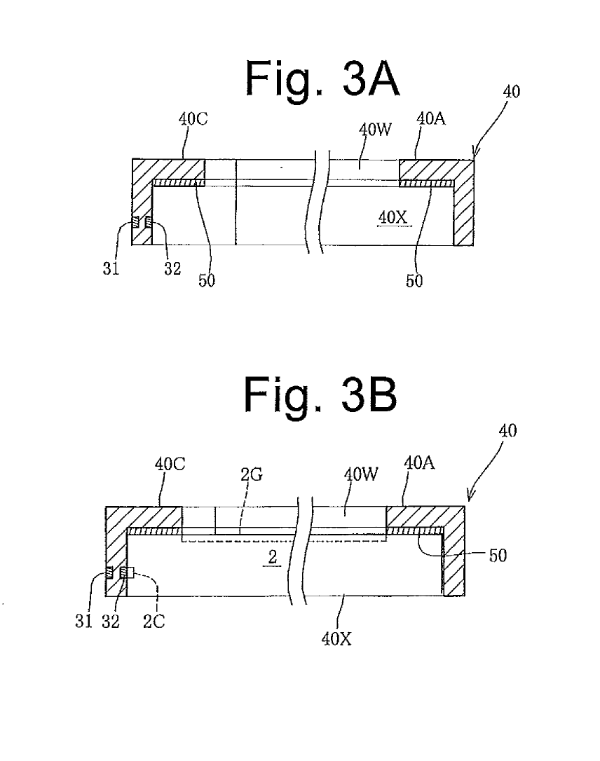

The read/write function providing device 10 is capable of wireless communication with an IC card etc. and includes a first antenna 21, a second antenna 22, an external connector 31 that can be connected to an external device, an internal connector 32 that can be connected to the input-output connector 2C of the display device 2, and a casing 40 including the first and second antennas 21 and 22, the external connector 31, and the internal connector 32, as shown in FIGS. 2, 3A, and 3B,

As shown in FIG. 3A, the casing 40 formed into a rectangular parallelepiped shape includes: a fitting concave portion 40X that is provided on the bottom of the casing 40 and fitted with an upper portion of the display device 2 including its top surface; and an opening (hereinafter referred to as a window) 40W that is provided on the top surface of the casing 40 and allows the display screen 2G of the display device 2 to be exposed to the outside. The material for forming the casing 40 may be any of a highly stiff material (such as a metal), an elastic material (such as a metal or plastic), and a stretchable material (such as a silicon resin). The window 40W is formed into a rectangular shape. The fitting concave portion 40X and the window 40W are in communication with each other. Therefore, when the read/write function providing device 10 is attached to the display device 2, the upper portion of the display device 2 including its top surface is fitted into the fitting concave portion 40X (see FIG. 3B), and the display screen 2G is exposed from the window 40W (see FIG. 1). An accommodating concave portion that accommodates the upper portion of the display device 2 including its top surface may be used instead of the fitting concave portion 40X. The window 40W may be an opening, or a light-transmitting member such as glass may be provided in the opening.

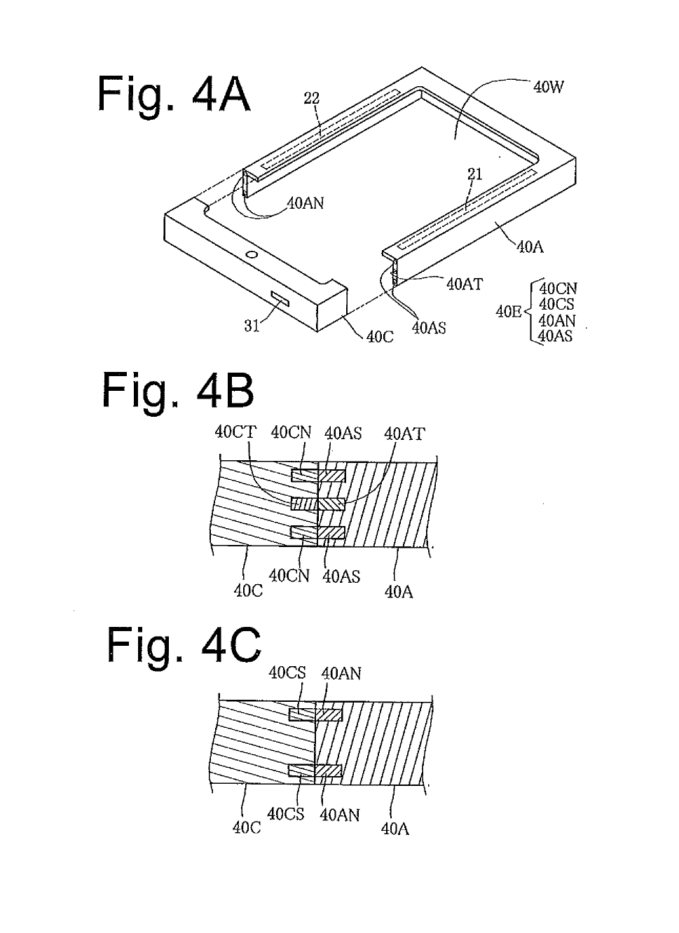

As shown in FIG. 4A, the first antenna 21 and the second antenna 22 are disposed on the top surface side of the casing 40. The external connector 31 is disposed on a side surface of the casing 40. The external connector 31 may be, for example, a USB connector. The casing 40 includes: a connector casing 40C including the external connector 31; an antenna casing 40A configured to be attachable to and detachable from the connector casing 40C and including the first and second antennas 21 and 22; and an attaching-detaching mechanism 40E that allows the connector casing 40C to be attached to and detached from the antenna casing 40A.

As shown in FIG. 4B, S-pole magnets 40AS with their S-pole exposed and an antenna-side internal terminal 40AT are disposed on a side face of the antenna casing 40A to which the connector casing 40C is attached. N-pole magnets 40CN with their N-pole exposed and a connector-side internal terminal 40CT are disposed on a side face of the connector casing 40C to which the antenna casing 40A is attached. When the antenna casing 40A is attached to the connector casing 40C, the S-pole magnets 40AS and the N-pole magnets 40CN face each other, and the antenna-side internal terminal 40AT is electrically connected to the connector-side internal terminal 40CT.

As shown in FIG. 4C, N-pole magnets 40AN with their N-pole exposed are disposed on a side face of the antenna casing 40A to which the connector casing 40C is attached. S-pole magnets 40CS with their S-pole exposed are disposed on a side face of the connector casing 40C to which the antenna casing 40A is attached. When the antenna casing 40A is attached to the connector casing 40C, the N-pole magnets 40AN face the S-pole magnets 40CS.

As described above, the magnets 40AS, 40AN, 40CS, and 40CN form the attaching-detaching mechanism 40E. The orientation of the connector casing 40C when it is attached to the antenna casing 40A is uniquely determined through the attaching-detaching mechanism 40E.

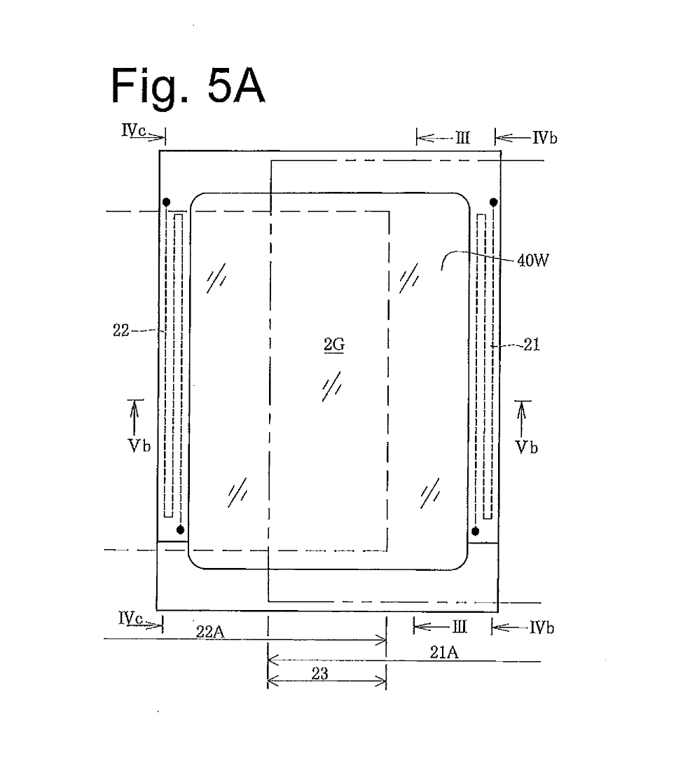

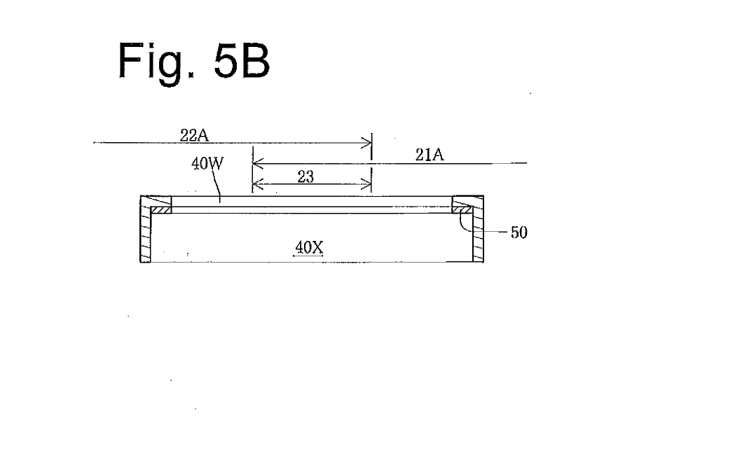

As shown in FIG. 5A, the first antenna 21 and the second antenna 22 are built into the casing 40 so as to be disposed on opposite sides of the window 40W. The casing 40 is formed from a light-transmitting material. Therefore, the first antenna 21 and the second antenna 22 can be visually recognized from the outside of the casing 40. When the casing 40 is formed from a light-shielding material, identifying marks indicting the formation positions of the first antenna 21 and the second antenna 22 may be provided on the top surface of the casing 40 at positions at which the first antenna 21 and the second antenna 22 are formed. The first antenna 21 and the second antenna 22 are disposed in the casing 40 such that a detectable area 21A over which the first antenna 21 can detect radio waves overlaps a detectable area 22A over which the second antenna 22 can detect radio waves. A wireless communication path provided by the first and second antennas 21 and 22, i.e., the overlapping portion 23 of the detectable areas 21A and 22A, is located above the window 40W (see FIG. 5B).

Next, the display device 2 will be described in detail.

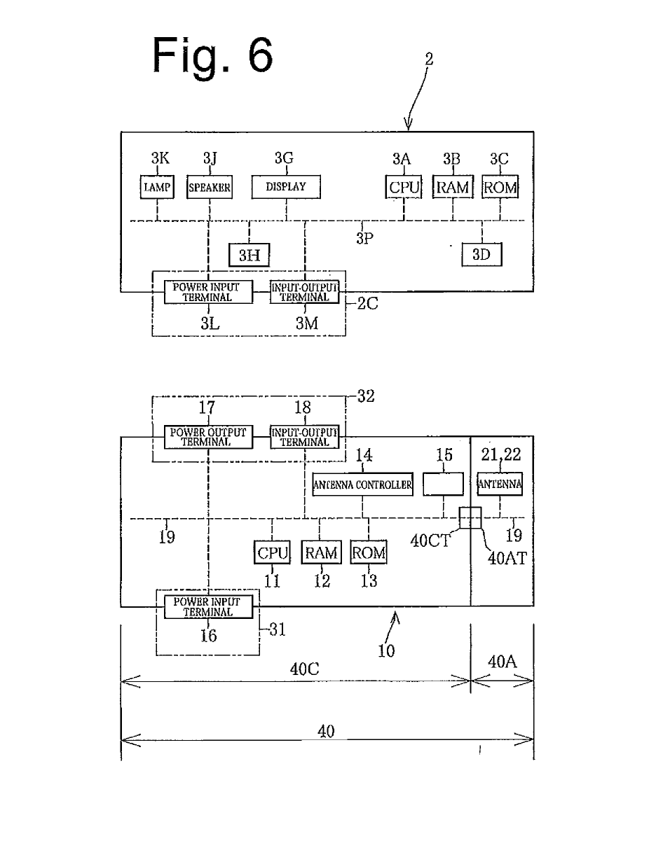

As shown in FIG. 6, the display device 2 includes a CPU 3A, a RAM 3B, a ROM 3C, a storage unit 3D, a display 3G, a touch panel 3H, a speaker 3J, a lamp 3K such as an LED, a power input terminal 3L, a signal input-output terminal 3M, and a bus 3P for electrically connecting these components.

The CPU 3A is a so-called central processing unit and executes various programs to implement various functions of the display device 2. The RAM 3B is used as a work area of the CPU 3A. The ROM 3C stores a basic OS executed by the CPU 3A. The storage unit 3D is composed of a hard disk drive including a magnetic disk, a nonvolatile semiconductor flash memory, etc. and stores various programs (e.g., a wireless communication support application) executed by the CPU 3A, data obtained by execution of programs, etc.

The display 3G is output means to which the results of an executed program are outputted and is, for example, a liquid crystal display. A portion of the display 3G that is exposed from the casing 2A forms the display screen 2G (see FIG. 2). The touch panel 3H is used mainly to operate the display device 2. The speaker 3J outputs prescribed sound in response to execution of a program. The lamp 3K is switched between three states, i.e., ON, flashing, and OFF, in response to execution of a program.

The power input terminal 3L receives electric power from an external power source and supplies the received power to each of the components of the display device 2. The signal input-output terminal 3M is used to communicate with the read/write function providing device 10. The power input terminal 3L and the signal input-output terminal 3M are disposed in the input-output connector 2C. The display device 2 may include a battery for supplying power to each of the components of the display device 2 and other devices (e.g., the read/write function providing device 10). In such a case, the power input terminal 3L functions as a power output terminal for supplying power to other devices.

Next, the read/write function providing device 10 will be described.

The read/write function providing device 10 is used to receive radio waves and output a signal generated on the basis of the received radio waves to the display device 2. The read/write function providing device 10 includes a CPU 11, a RAM 12, a ROM 13, the first and second antennas 21 and 22, an antenna controller 14, an operation button 15, a power input terminal 16, a power output terminal 17, a signal input-output terminal 18, and a bus (connection circuit) 19 for electrically connecting these components.

The CPU 11 is a so-called central processing unit and executes various programs to implement various functions of the read/write function providing device 10. The RAM 12 is used as a work area of the CPU 11. The ROM 13 stores a basic OS executed by the CPU 11.

The first and second antennas 21 and 22 are used to form a path for communication with an IC card and can each receive radio waves from the IC card and generate a prescribed electric signal.

The operation button 15 is operated to start wireless communication with an IC card and disposed in the casing 40 (see FIG. 1).

The power input terminal 16 receives electric power from an external power source and supplies the received power to each of the components of the read/write function providing device 10. The power output terminal 17 is used to supply the power from the external power source to the display device 2. The signal input-output terminal 18 is used to communicate with the display device 2. The read/write function providing device 10 may include a battery for supplying power to each of the components of the read/write function providing device 10 and other devices (e.g., the display device 2). In such a case, the power input terminal 16 functions as a power output terminal for supplying power to other devices.

The power input terminal 16 is disposed in the external connector 31. The power output terminal 17 and the signal input-output terminal 18 are disposed in the internal connector 32.

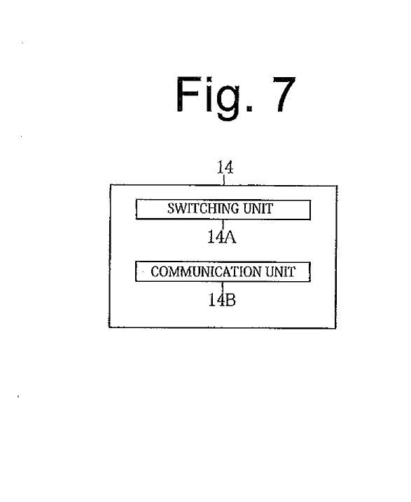

As shown in FIG. 7, the antenna controller 14 controls the first and second antennas 21 and 22 independently and includes: a switching unit 14A that switches between a mode in which an electric signal generated when the first and second antennas 21 and 22 receive radio waves is enabled (a communication enabled mode) and a mode in which the electric signal is disabled (a communication disabled mode); and a communication unit 14B for communication with an external device during the communication enabled mode. The communication unit 14B supports at least one communication protocol. Preferably, the communication unit 14B supports at least two communication protocols. Preferably, these communication protocols are not supported by the display device 2.

Next, the usage of the read/write function providing device 10 will be described.

First, as shown in FIGS. 1 and 2, the read/write function providing device 10 is attached to the display device 2. Then the display screen 2G of the display device 2 is exposed from the window 40W of the read/write function providing device 10. Therefore, even after the read/write function providing device 10 is attached to the display device 2, the overall visibility of the display screen 2G is not impaired.

As shown in FIG. 5A, the antennas 21 and 22 are disposed on the top surface of the casing 40 of the read/write function providing device 10. Therefore, when an IC card is held near the display screen 2G, wireless communication with the IC card can be performed. As described above, the read/write function providing device 10 connected to the display device 2 through the input-output connector 2C and the internal connector 32 performs wireless communication with the IC card, and the display device 2 can read data in the IC card and write data on the IC card.

The position over which the IC card is to be held is located in the vicinity of the display screen 2G at which the user gazes, so that the user is easily aware of the antennas 21 and 22 themselves disposed around the window 40W or identifying marks indicating the formation positions of the antennas 21 and 22. Therefore, the user can readily find the position over which the IC card is to be held.

The overlapping portion 23 in which both the first and second antennas 21 and 22 can detect radio waves is located above the window 40W, so that the sensitivity of the first and second antennas 21 and 22 is high at positions above the window 40W, i.e., immediately above the display screen 2G. Therefore, when the user holds the IC card near the display screen 2G, wireless communication with the IC card is enabled.

As shown in FIG. 4A, the casing 40 includes the connector casing 40C and the antenna casing 40A. Therefore, when one of the connector casing 40C and the antenna casing 40A is attached to the display device 2 and then the other is attached thereto, the display device 2 is thereby accommodated in the casing 40. In addition, since the fitting concave portion 40X that accommodates the display device 2 is formed by attaching the connector casing 40C to the antenna casing 40A (see FIG. 3A), the operation for accommodating the display device 2 can be performed easily. The attaching-detaching mechanism 40E is provided in the casing 40. Therefore, when the connector casing 40C and the antenna casing 40A are attached to each other, they can be aligned easily. In addition, the connector-side internal terminal 40CT is disposed in the connector casing 40C. Therefore, by attaching the connector casing 40C to the antenna casing 40A, the read/write function providing device 10 can be connected to the display device 2.

Passive components such as the first and second antennas 21 and 22 are disposed in the antenna casing 40A, and active components such as the CPU 11 and the RAM 12 are disposed in the connector casing 40C. Therefore, if a component disposed in the connector casing 40C, e.g., a passive component, is broken, it is sufficient to replace only the connector casing 40C.

As shown in FIG. 6, the casing 40 includes: the power input terminal 16 for receiving power from an external power source and supplying the received power to each of the components of the read/write function providing device 10; and the power output terminal 17 for supplying the power from the external power source to the display device 2. Therefore, the power from the external power source can be supplied, through the read/write function providing device 10, to the display device 2 with the read/write function providing device 10 attached thereto.

When the operation button 15 is operated, the CPU 11 outputs a control signal for starting the support application to the display device 2, and the switching unit 14A switches from the communication disabled mode to the communication enabled mode. In the display device 2, when the input of the control signal is detected, the CPU 3A starts the wireless communication support application.

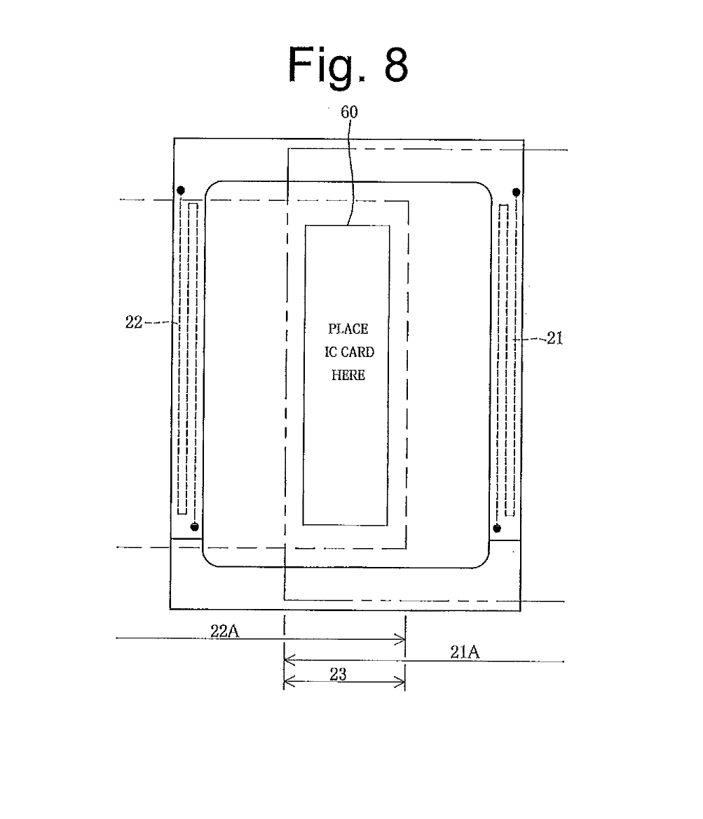

When the wireless communication support application is started, an image 60 urging the user to hold an IC card thereover is displayed on the display screen 2G of the display device 2 (see FIG. 8). The support application is automatically terminated a predetermined period after the start of the application. Similarly, the switching unit 14A switches from the communication enabled mode to the communication disabled mode a predetermined period after the start of the support application. Therefore, the user can immediately find the place over which the IC card is to be held. The switching unit 14A maintains the communication enabled mode only for a required period and then switches to the communication disabled mode. Therefore, unnecessary wireless communication with an IC card can be prevented.

In the above embodiment, in response to the output of the operation signal from the operation button 15, the communication disabled mode is switched to the communication enabled mode, and the image 60 urging the user to hold the IC card thereover is displayed on the display screen 2G of the display device 2. However, the present invention is not limited thereto. The trigger for displaying the image 60 may not be the operation signal from the operation button 15. Instead, the image 60 may be displayed as follows. Specifically, the image 60 urging the user to hold an IC card thereover is displayed on the display screen 2G of the display device 2 (see FIG. 8) when the wireless communication support application is started in the display device 2. Then the CPU 11 reads a signal indicating the start of the support application from the display device 2. When the signal indicating the start of the support application is read, the switching unit 14A switches from the communication disabled mode to the communication enabled mode. When an IC card is held near the image urging the user to hold the IC card thereover, wireless communication with the IC card can be performed. The support application is automatically terminated a predetermined period after the start of the support application. The switching unit 14A switches from the communication enabled mode to the communication disabled mode a predetermined period after the start of the support application. The switching unit 14A may switch from the communication enabled mode to the communication disabled mode when a signal indicating termination of the support application is detected.

Instead of displaying, on the display screen 2G, the image 60 urging the user to hold the IC card thereover, the lamp 3K (see FIG. 6) may be turned on or off or caused to blink, or a beep from the speaker 3J (see FIG. 6) may be used.

A radio wave shielding sheet 50 may be provided such that it is positioned between a display device antenna 2R provided in the display device 2 and the first or second antenna 21, 22 when the read/write function providing device 10 is attached to the display device 2, as shown in FIG. 2. The material forming the radio wave shielding sheet 50 maybe any known electromagnetic shield material such as nickel, iron, or permalloy. With the radio wave shielding sheet 50, interference between the terminal antenna provided in the display device 2 and the first and second antennas 21 and 22 can be prevented, so that reliable communication between the IC card and the first and second antennas 21 and 22 can be achieved. The radio wave shielding sheet 50 may be disposed in the casing 40 or the casing of the displace device 2.

As shown in FIGS. 6 and 7, the communication unit 14B of the antenna controller 14 is disposed in the connector casing 40C. Therefore, when connector casings 40C provided with different communication units 14B are prepared, wireless communication through any communication protocol can be performed. For example, when the display device 2 has a communication unit that supports a communication protocol of type A, it is preferable that the communication unit 14B disposed in the connector casing 40C support a communication protocol of type B or type C different from type A. In this case, although the display device 2 alone can implement communication of type A, the use of the read/write function providing device 10 allows communication of type B and type C. When a communication unit 14B provided in a first connector casing 40C supports a communication protocol of type B and a communication unit 14B provided in a second connector casing 40C supports a communication protocol of type C, communication according to the communication protocol of type B or C can be performed by selecting one of the first and second connector casings 40C and attaching the selected connector casing 40C to the antenna casing 40A. Therefore, the use of a plurality of connector casings 40C and one antenna casing 40A allows a read/write function providing device that can support various types of communication protocols to be configured.

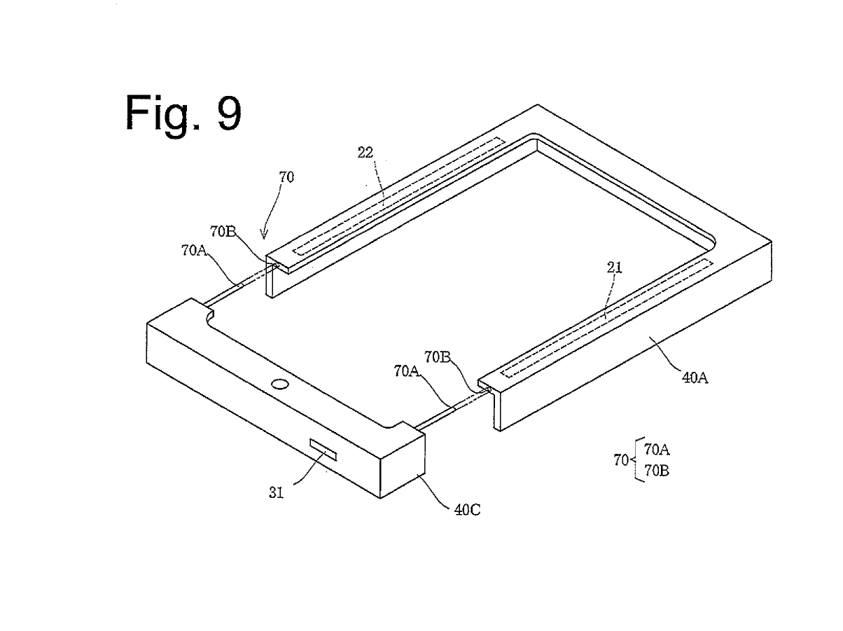

As shown in FIG. 9, a moving mechanism 70 that allows the connector casing 40C to move relative to the antenna casing 40A may be provided. The moving mechanism 70 includes slide bars 70A disposed in the connector casing 40C and insertion holes 70B disposed in the antenna casing 40A. Each slide bar 70A is disposed so as to protrude from a side face of the connector casing 40C that faces the antenna casing 40A. Each insertion hole 70B has dimensions allowing insertion of a slide bar 70A and is formed on a side face of the antenna casing 40A that faces the connector casing 400. This moving mechanism 70 allows the connector casing 40C attached to the antenna casing 40A to freely move between a fitting concave portion-forming position at which the fitting concave portion is formed and a position spaced apart from the antenna casing 40A.

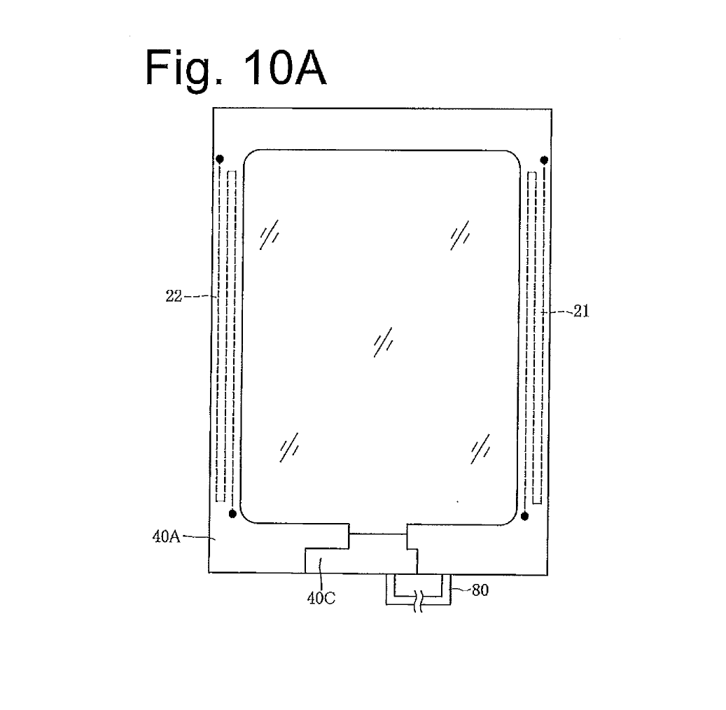

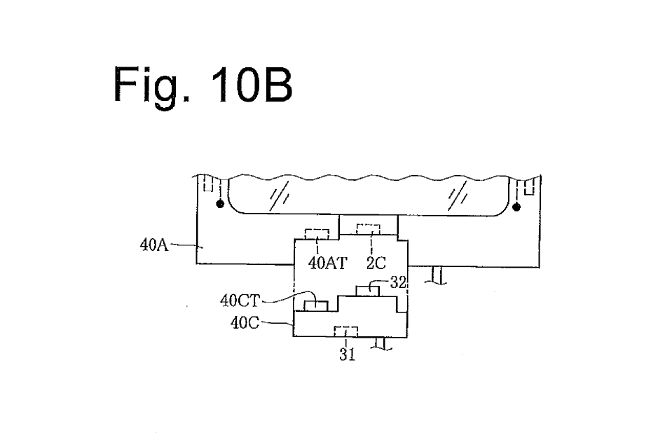

In the above embodiment, the connector casing 40C that forms one entire side of the rectangular window 40W is configured to be attachable to and detectable from the antenna casing 40A, but the present invention is not limited thereto. As shown in FIGS. 10A and 10B, a connector casing 40C that forms part of one side of the rectangular window 40W and is configured to be attachable to and detectable from the antenna casing 40A may be used. In this case, a coupler 80 for coupling the antenna casing 40A and the connector casing 40C may be provided.

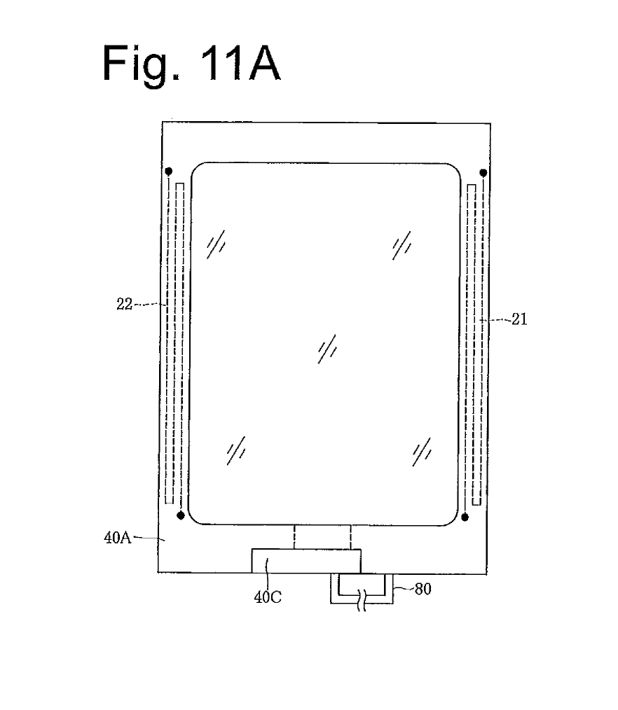

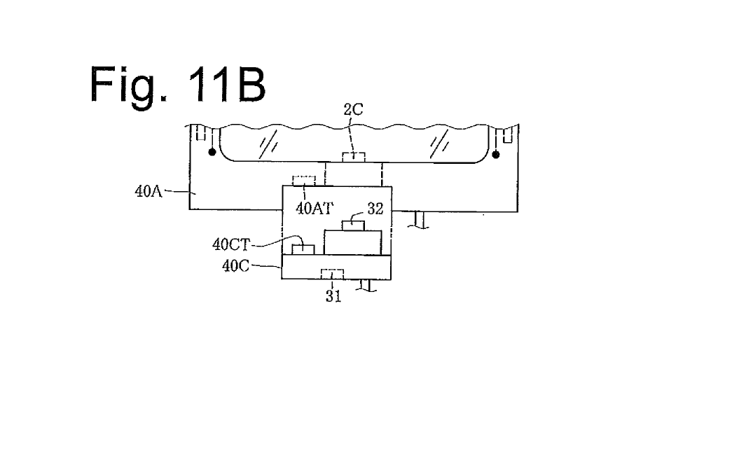

In the above embodiment, the fitting concave portion 40X provided in the casing 40 is formed by attaching the connector casing 400 to the antenna casing 40A, but the present invention is not limited thereto. For example, the casing 40 may include an antenna casing 40A and a connector casing 40C as shown in FIGS. 11A and 11B. In this case, the fitting concave portion 40X is formed in the antenna casing 40A. A through hole 40Y for inserting the internal connector 32 is provided in the antenna casing 40A. When the above connector casing 40C is attached to the above antenna casing 40A, the internal connector 32 is inserted into the through hole 40Y and then fitted to the input-output connector 2C of the display device 2, and the connector-side internal terminal 40CT is fitted to the antenna-side internal terminal 40AT.

The installation positions of the antennas 21 and 22 within the casing 40 may be located on the outer periphery or inner periphery of the display screen 2G, so long as the antennas 21 and 22 are located in the vicinity of the display screen 2G. The positions of the antennas 21 and 22 are not limited to positions on the top surface of the casing 40, so long as the overlapping portion 23 is located above the display screen 2G. The antennas 21 and 22 may be disposed on side surfaces of the casing, for example.

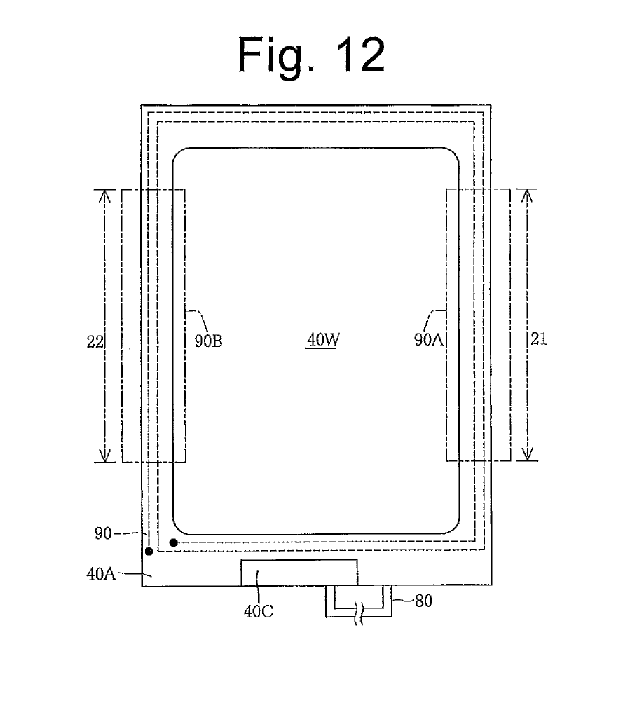

The number of antennas provided in the read/write function providing device 10 may be one or three or more. When one antenna wire extending helically so as to surround the display screen is used, parts of the antenna wire maybe used as independent antennas. For example, as shown in FIG. 12, when an antenna composed of one antenna wire 90 extending helically so as to surround the rectangular display screen 2G is used, one part 90A of the antenna wire 90 may be used as the first antenna 21, and another part 90B may be used as the second antenna 22. Preferably, the one part 90A and the other part 90B face each other through the display screen 2G. In this manner, a wireless communication path provided by the first and second antennas 21 and 22 can be positioned above the window 40W.

The read/write function providing device of the present invention is not limited to the above-described read/write function providing device 10 and may be configured to be attachable to and detectable from the display device 2 with an additional component integrated with the read/write function providing device. The additional component may be a cover, a jacket, etc. When a folded-in-half-type cover or jacket is used, the read/write function providing device integrated therewith is used as, for example, a diary-type, book cover-type, wallet-type, or notebook-type read/write function providing device.

The read/write function providing device of the present invention is not limited to the above-described embodiments. It is appreciated that various modifications may be made without departing from the scope of the invention.

The entire disclosure of Japanese Patent Application No. 2012-284045 filed on Dec. 27, 2012 including specification, claims, drawings, and summary are incorporated herein by reference in its entirety.

What is claimed is:

1. A read/write function providing device configured to be attachable to and detachable from a display device provided with a display screen, the read/write function providing device comprising:
an antenna unit for forming a wireless communication path for wireless communication with an external communication device, the antenna unit including a first section and a second section;
an interface unit that is connectable to the display device; and
a connection circuit that connects the antenna unit to the interface unit,
wherein, when the read/write function providing device is attached to the display device, the wireless communication path provided by a detectable area of the first section of the antenna unit and a detectable area of the second section of the antenna unit is located above the display screen.

2. The read/write function providing device according to claim 1, wherein, when the read/write function providing device is attached to the display device, the antenna unit is located at a circumference of the display screen.

3. The read/write function providing device according to claim 1, wherein, when the read/write function providing device is attached to the display device, an overlapping area of the detectable area of the first section and the detectable area of the second section is located above the display screen.

4. The read/write function providing device according to claim 1, further comprising a casing having the antenna unit and the interface unit and including an accommodating section formed therein, for accommodating the display device when the read/write function providing device is attached to the display device,
wherein the casing includes:
an antenna casing including the antenna unit; and
an interface unit casing including the interface unit and configured to be attachable to and detachable from the antenna casing, and
wherein the accommodating section is formed by attaching the interface unit casing to the antenna casing.

5. The read/write function providing device according to claim 4, further comprising a moving mechanism that allows the interface unit casing to move relative to the antenna casing between an accommodating section-forming position at which the accommodating section is formed and an escape position escaped from the accommodating section-forming position.

6. The read/write function providing device according to claim 5, further comprising an attaching-detaching mechanism that allows the interface unit casing to be attached to and detached from the antenna casing, the attaching-detaching mechanism including a magnet.

7. The read/write function providing device according to claim 1, further comprising a casing having the antenna unit and the interface unit and including an accommodating section formed therein, for accommodating the display device when the read/write function providing device is attached to the display device,
wherein the casing includes:
an antenna casing including the antenna unit; and
an interface unit casing including the interface unit and configured to be attachable to and detachable from the antenna casing, and
wherein the accommodating section is formed in the antenna casing.

8. The read/write function providing device according to claim 4, wherein the casing includes:
an external power source-side power receiving unit that receives power from an external power source; and
a display device-side power supply unit that supplies the power received by the external power source-side power receiving unit to the display device.

9. The read/write function providing device according to claim 8, wherein the interface unit casing includes:
the external power source-side power receiving unit; and
the display device-side power supply unit.

10. The read/write function providing device according to claim 4, wherein the casing is formed into a rectangular parallelepiped shape, and
wherein, when the read/write function providing device is attached to the display device, the interface unit casing forms part of a side surface of the casing, with a surface of the casing on a side close to the display screen being defined as a top surface.

11. The read/write function providing device according to claim 1, further comprising a radio wave shielding member that is positioned between a display device antenna provided in the display device and the antenna unit when the read/write function providing device is attached to the display device.

12. The read/write function providing device according to claim 1, further comprising a signal output unit that outputs the first control signal for the display device, and
wherein the first control signal is used to instruct the display device to show, on the display screen, a display indicating that communication between the antenna unit and the external communication device is enabled.

13. The read/write function providing device according to claim 12, further comprising an operation button provided in the casing, and
wherein the signal output unit outputs, as the first control signal, an operation signal from the operation button to the display device.

14. The read/write function providing device according to claim 12, further comprising a switching unit that switches between a communication enabled mode in which the communication between the antenna unit and the external communication device is enabled and a communication disabled mode in which the communication is disabled, and
wherein, when the signal output unit outputs the first control signal to the display device, the switching unit switches to the communication enabled mode.

15. The read/write function providing device according to claim 1, further comprising a signal input unit to which the second control signal outputted from the display device is inputted, and
wherein the second control signal outputted from the display device is used to switch to the communication enabled mode in which communication between the antenna unit and the external communication device is enabled.

16. The read/write function providing device according to claim 15, further comprising a switching unit that switches between the communication enabled mode in which the communication between the antenna unit and the external communication device is enabled and a communication disabled mode in which the communication is disabled, and
wherein, when the second control signal outputted from the display device is inputted to the signal input unit, the switching unit switches to the communication enabled mode in which the communication between the antenna unit and the external communication device is enabled.

17. The read/write function providing device according to claim 1, further comprising a communication unit that communicates with the external communication device through the antenna unit, and
wherein, when a communication protocol executed by a display device-side communication unit provided in the display device is defined as a display device-side communication protocol, a communication protocol executed by the communication unit is different from the display device-side communication protocol.
